(19) United States
(12) Patent Application Publication
(10) Pub. No.: US 2011/0102348 A1
(43) Pub. Date: May 5, 2011

(54) DUAL WIRELESS COMMUNICATOR AND HUMAN INTERFACE DEVICE

(75) Inventors: Dov Moran, Kfar Saba (IL); Itay Sherman, Hod Hasharon (IL); Eyal Bychkov, Hod Hasharon (IL); Uri Ron, Tel Aviv (IL)

(73) Assignee: MODU LTD., Kfar Saba (IL)

(21) Appl. No.: 12/916,545

(22) Filed: Oct. 31, 2010

Related U.S. Application Data
(60) Provisional application No. 61/257,073, filed on Nov. 2, 2009.

(51) Int. Cl. G06F 3/041

(52) U.S. Cl. 345/173

(57) ABSTRACT

A communication system, including a modular wireless communicator, including a modem for transmitting and receiving signals wirelessly, and a touch-sensitive display, and a mobile computer, including a housing with a cavity for inserting the modular wireless communicator therein such that the touch-sensitive display is exposed through the housing and accessible for user inputs, and a processor, mounted within the housing, for controlling the modem and for running an operating system that performs computer tasks in response to user inputs detected by the touch-sensitive display, when the modular wireless communicator is inserted in the housing.

### CROSS REFERENCES TO RELATED APPLICATIONS

This application claims benefit of U.S. Provisional Application No. 61/257,073, entitled DUAL WIRELESS COMMUNICATOR AND HUMAN INTERFACE DEVICE, filed on Nov. 2, 2009 by inventors Dov Moran, Itay Sherman, Eyal Bychkov and Uri Ron.

### FIELD OF THE INVENTION

The field of the present invention is modular wireless communicators.

### BACKGROUND OF THE INVENTION

Most mobile computers have a keyboard and a pointing device built in. The pointing device may be a touch pad, a track ball or a pointing stylus. Users often connect a corded or cordless mouse to a mobile computer, for easier operation. However, a separate mouse is cumbersome for a user to carry with him.

### SUMMARY OF THE DESCRIPTION

Aspects of the present invention relate to a combined smart phone and netbook computer. A “netbook computer”, also referred to as a notebook computer and a sub-notebook computer, is a small, lightweight and inexpensive laptop computer suited for general computing and for accessing web-based applications. The smart phone has a modular form factor and inserts into a jacket that includes a keypad, a large display, and additional storage in the form of a hard disk drive of a solid-state disk. The jacket converts the smart phone into a fully functioning connected netbook.

The present invention is of advantage to consumers, in avoiding the extra cost and data synchronization complexity of separate independent phone and netbook. The consumer carries a single combined device, and has ready access to all of his personal data, which is always synchronized. Moreover, the combined device switches easily between netbook and phone form factors and functionality, by simply inserting and detaching the phone module from the netbook jacket.

The present invention is also of advantage to operators, in providing a low cost netbook (under $100) that can be subsidized to users. The phone and modem of the netbook share the same SIM, and thus operators can achieve greater average return per unit.

Further aspects of the present invention relate to a modular communicator that has a dual function as a human interface device (HID) and as a wireless communicator. For the HID, the modular communicator functions as a touch pad for a mobile computer when connected thereto. The modular communicator includes a touch-sensitive display which positions at a surface of the mobile computer when the modular communicator is engaged with the mobile computer. The touch-sensitive display is thus visible and accessible to a user of the mobile computer, and functions as a touch pad for the user to input pointing commands to the mobile computer.

The touch-sensitive display may be further operable to display system messages and notifications for the mobile computer, when the modular communicator is engaged with the mobile computer. Such system messages and notifications include inter alia a power bar, a network status and a storage capacity.

The touch-sensitive display may be further operable as a touch-based user interface for specific applications, and may be further operable to provide soft keys for specific commands.

In a first embodiment of the present invention, the mobile computer has its own pointing device. When the modular communicator is engaged with the mobile computer, the communicator's touch-sensitive display functions either as a secondary pointing device in conjunction with the mobile computer's pointing device, or as a primary pointing device in lieu of the mobile computer's pointing device. In a second embodiment of the present invention, the mobile computer does not have its own pointing device.

There is thus provided in accordance with an embodiment of the present invention a communication system, including a modular wireless communicator, including a modem for transmitting and receiving signals wirelessly, and a touch-sensitive display, and a mobile computer, including a housing with a cavity for inserting the modular wireless communicator therein such that the touch-sensitive display is exposed through the housing and accessible for user inputs, and a processor, mounted within the housing, for controlling the modem and for running an operating system that performs computer tasks in response to user inputs detected by the touch-sensitive display, when the modular wireless communicator is inserted in the housing.

There is additionally provided in accordance with an embodiment of the present invention a modular wireless communicator, including a modem for transmitting and receiving signals wirelessly, a touch-sensitive display, an electrical connector, coupled with the modem and with the touch-sensitive display, for connection to a mobile computer, wherein the modem serves as a modem for the mobile computer and the touch-sensitive display serves as a touch-based input device for the mobile computer, when the electrical connector is connected to the mobile computer.

There is further provided in accordance with an embodiment of the present invention a mobile computer, including a housing with a cavity for inserting a modular wireless communicator therein, the modular wireless communicator including a modem and a touch-sensitive display, wherein the touch-sensitive display is exposed through the housing and accessible for user inputs when the modular wireless communicator is inserted in the housing, and a processor, mounted within the housing, for controlling the modem and for running an operating system that performs computer tasks in response to user inputs detected by the touch-sensitive display, when the modular wireless communicator is inserted in the housing.

### BRIEF DESCRIPTION OF THE DRAWINGS

The present invention will be more fully understood and appreciated from the following detailed description, taken in conjunction with the drawings in which:

FIG. 1 is an illustration of a modular communicator that inserts into a netbook computer to function as a component thereof, in accordance with an embodiment of the present invention;

FIG. 2 is a simplified block diagram of the modular communicator of FIG. 1, in accordance with an embodiment of the present invention;

FIG. 3 is a simplified block diagram of the netbook computer of FIG. 1, in accordance with an embodiment of the present invention;

FIG. 4 is a simplified illustration of a communication system, with a mobile computer, and with a modular wireless communicator that has dual functionality as a touch-sensitive input device for the mobile computer when the modular wireless communicator is connected to the mobile computer, in accordance with an embodiment of the present invention;

FIG. 5 is a simplified illustration of a configuration of the mobile computer and the modular wireless communication with the touch-sensitive input device facing the outside of the mobile computer, in accordance with an embodiment of the present invention;

FIG. 6 is a simplified illustration of the mobile computer and the modular wireless communicator when the mobile computer is closed, in accordance with an embodiment of the present invention;

FIG. 7 is a simplified illustration of the mobile computer and wireless communicator for a mobile computer having a tablet form factor, in accordance with an embodiment of the present invention; and

FIG. 8 is a simplified illustration of a configuration of the mobile computer and the modular wireless communicator for a mobile computer having a tablet form factor with the touch-sensitive input device facing the back of the mobile computer, in accordance with an embodiment of the present invention.

### DETAILED DESCRIPTION

Aspects of the present invention relate to a combined smart phone and netbook computer. A “netbook computer”, also referred to as a notebook computer and a sub-notebook computer, is a small, lightweight and inexpensive laptop computer suited for general computing and for accessing web-based applications. The smart phone has a modular form factor and inserts into a jacket that includes a keypad, a large display, and additional storage in the form of a hard disk drive of a solid-state disk. The jacket converts the smart phone into a fully functioning connected netbook.

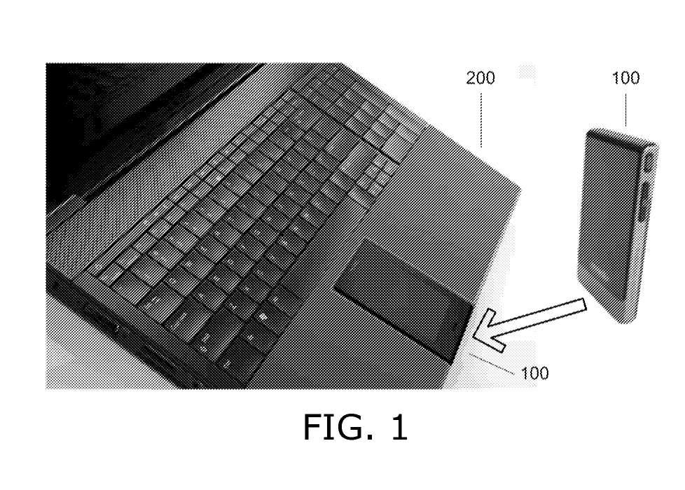

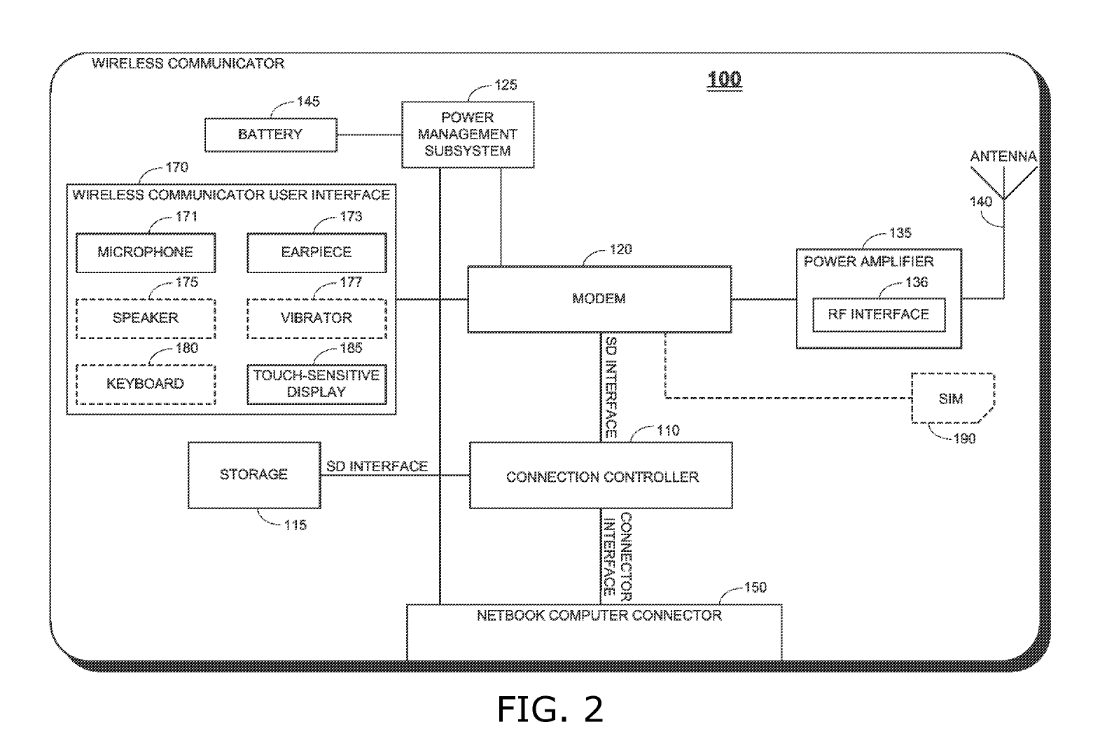

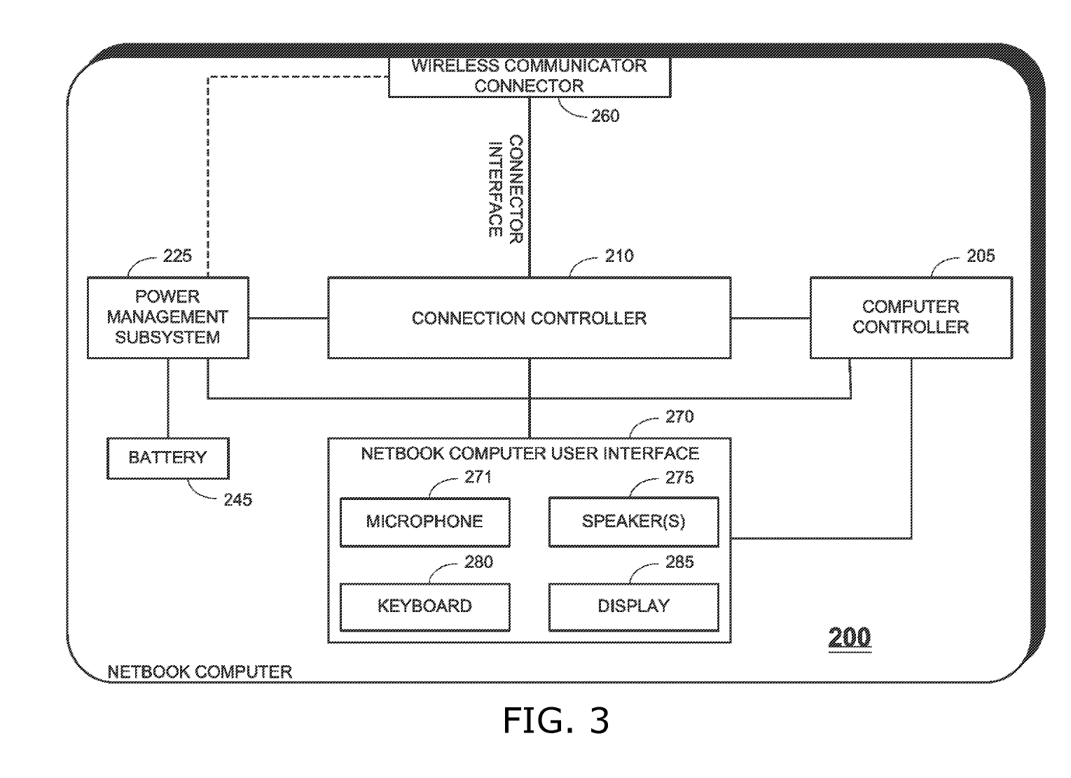

Reference is made to FIG. 1, which is an illustration of a modular communicator 100 that inserts into a netbook computer 200 to function as a component thereof, in accordance with an embodiment of the present invention. Reference is also made to FIGS. 2 and 3, which are respective simplified block diagrams of modular communicator 100 and of netbook computer 200, in accordance with an embodiment of the present invention.

Modular communicator 100 includes six primary components, as follows: a connector controller 110, a memory storage 115, a base band modem 120 for sending and receiving voice and data communications, a power management subsystem 125, a power amplifier 135 and a user interface 170.

Connector controller 110 executes programmed instructions that control the data flow between modular communicator 100 and netbook computer 200. Modem 120 controls the wireless communication functionality of modular communicator 100.

Power management subsystem 125 includes circuitry for charging a battery 145.

Power amplifier 135 includes a radio frequency (RF) interface 136, and is connected to an optional internal antenna 140.

User interface 170 includes a microphone 171, an earpiece 173, and touch-sensitive display 185. User interface 170 also includes an optional speaker 175, an optional vibrator 177 and an optional keyboard 180. It will be appreciated by those skilled in the art that user interface 170 may include additional components.

Modular communicator 100 may include an optional camera.

Modular communicator 100 includes a mobile computer connector 150 for electronically connecting wireless communicator 100 to network computer 200. Modular communicator 100 optionally includes a subscriber identification module (SIM) 190.

In accordance with an embodiment of the present invention, the interface between connector controller 110 and storage 115, and the interface between connector controller 110 and modem 120 are SD interfaces. The interface between connector controller 110 and mobile computer connector 150 is a special purpose connector interface.

In one implementation of the present invention, modular communicator 100 is a core Android-based smart phone, with a QUALCOMM MSM7230 chipset. Modular communicator 100 has a small form factor, for ease of carrying and use, and supports full touch operation. Modular communicator 100 supports 3G (HSPA/EvDo), WLAN, BT, FM and GPS communication.

Netbook computer 200 may be a notebook computer, a sub-notebook computer, an ultra-mobile PC (UMPC), a mobile Internet device (MID), or such other portable computer. Netbook computer 200 includes six primary components, as follows: a computer controller 205, a connector controller 210, a memory storage 215, a wireless modem 220, a power management system 225 and a user interface 270.

Power management subsystem 225 includes circuitry for charging a battery 245.

User interface 270 includes a microphone 271, mono or stereo speakers 275, a keyboard 280 and a display 285, typically a 5″-11″display. It will be appreciated by those skilled in the art that user interface 270 may include additional components.

Regarding connectivity, network computer 200 includes a communicator connector 250 for electronically connecting modular communicator 100 to netbook computer 200. Network computer 200 may also include a USB hub and a plurality of USB connectors, in order to allow connection of additional peripherals. Additionally, other connectors, such as video out HDMI, DVI, VGA and S-video connectors, may also be included.

Netbook computer 200 includes a slot for modular communicator 100, and serves as a jacket for modular communicator 100 when modular communicator 100 is inserted in the slot. Moreover, in accordance with an embodiment of the present invention, modular communicator 100 serves as a touch pad for netbook computer 200, or as a secondary display for notebook computer 200, when modular communicator is inserted into the slot.

Netbook computer 200 may include an optional camera.

Netbook computer 200 optionally includes one or two antennas for diversity. “Antenna diversity” is the use of two or more antennas to improve the quality and reliability of a wireless link. Antenna diversity generally provides greater capacity and performance benefits than standard antennas. In some embodiments of the present invention, one antenna is in netbook computer 200, and another antenna is in modular communicator 100. In other embodiments of the present invention, two antennas are in netbook computer 200. In accordance with an embodiment of the present invention, the antenna(s) in network computer 200 cooperate with antenna 140 in communicator 100.

In accordance with an embodiment of the present invention, modular communicator 100 is able to operate at least two operating systems; namely, a mobile phone operating system such as Android, and a netbook computer operating system, such as Chrome. Modular communicator 100 functions as a full Android phone, when operating independently as a smart phone. In one implementation of the present invention, modular communicator 100 continues to operate as an Android phone with a modified user interface that conforms to the netbook experience, when inserted into the slot of netbook computer 200. In a second implementation of the present invention, modular communicator 100 switches to the Chrome operating system when inserted into the slot of netbook computer 200.

Phone calls received or initiated by netbook computer 200 continue on modular communicator 100, when modular communicator 100 is detached from netbook computer 100. Data on modular communicator 100 is synchronized with netbook computer 200, and no data is lost when modular communicator is inserted in or detached from netbook computer 200. Moreover, data on modular communicator 100 may be backed up on the hard disk drive or solid-state disk drive of netbook computer 200.

While modular communicator 100 is inserted into the slot of netbook computer 200, modular communicator 100 is charged from the power supply of netbook computer 200; i.e., from the internal battery of netbook computer 200 or from an external power supply to netbook computer 200.

It will be appreciate by those skilled in the art that various alternative hardware architectures may be implemented in modular communicator 100 and netbook computer 200, all within the scope of the present invention. One such alternative architecture is for modem 120 of modular communicator 100 to serve as controller of netbook computer 200, when modular communicator 100 is attached to netbook computer 200. In this embodiment, controller 205 is not present in netbook computer 200 and, as such, netbook computer 200 cannot function independently of modular communicator 100.

Further aspects of the present invention relate to a modular wireless communicator that has a dual function as a human interface device (HID). For the HID, the modular communicator functions as a touch pad for a mobile computer when connected thereto. Specifically, the wireless communicator includes a touch-sensitive display screen, which provides pointer input commands to the mobile computer, when the wireless communicator is inserted therein.

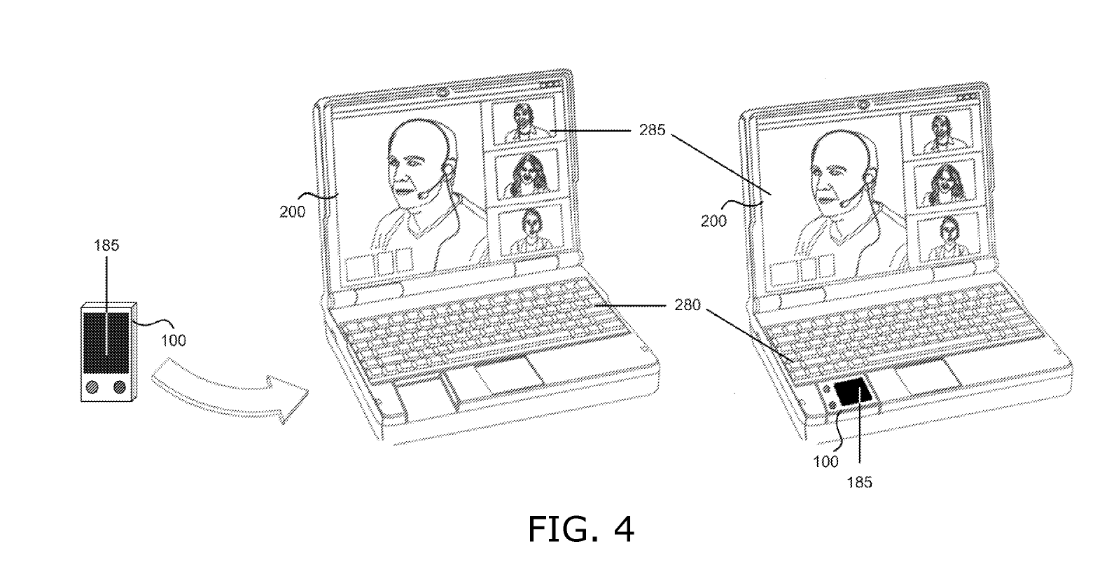

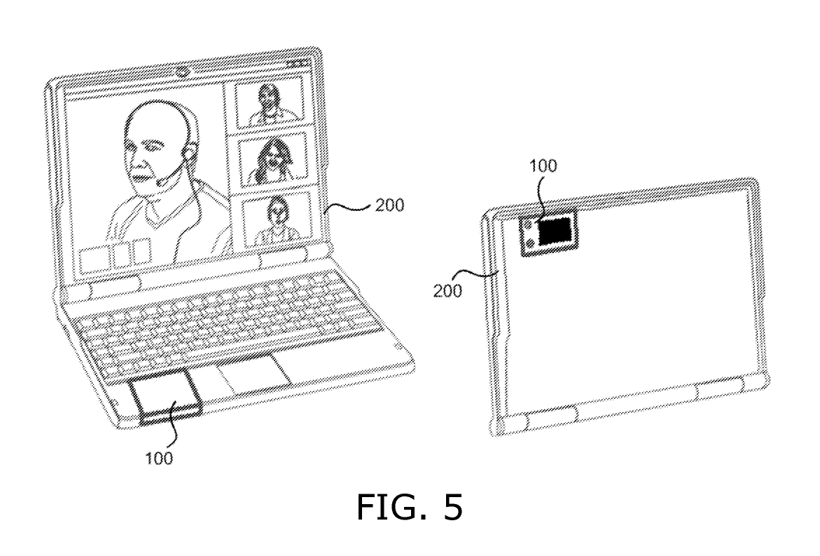

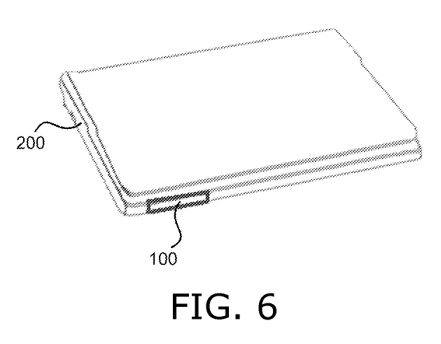

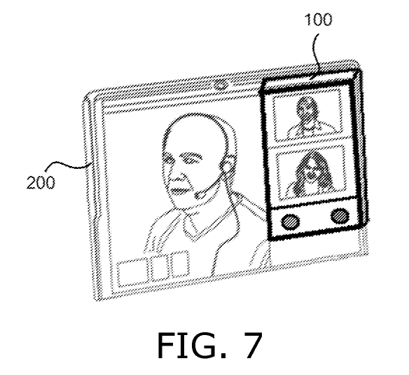

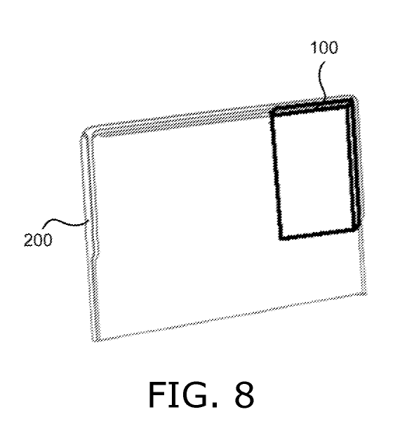

Reference is made to FIGS. 4-8, which are simplified illustrations of a communication system with modular communicator 100 and netbook computer 200, in accordance with embodiments of the present invention. FIG. 4 is a simplified illustration of a configuration with a touch-sensitive input device facing the inside of netbook computer 200. FIG. 5 is a simplified illustration of a configuration with the touch-sensitive input device facing the outside of netbook computer 200. FIG. 6 is a simplified illustration of the configuration of FIG. 5 when netbook computer 200 is closed. FIG. 7 is a simplified illustration with netbook computer 200 having a tablet form factor, and with the touch-sensitive input device facing the front of netbook computer 200. FIG. 8 is a simplified illustration with netbook computer 200 having a tablet form factor, and with the touch-sensitive input device facing the back of netbook computer 200.

When modular communicator 100 is connected to netbook computer 200, modular communicator 100 has dual functionality as a touch-sensitive input device for netbook computer 200.

As shown in FIG. 4, when modular communicator 100 is inserted in netbook computer 200, a surface portion of modular communicator 100 that includes a user interface is visible and accessible to a user through an opening in a surface of netbook computer 200. In accordance with an embodiment of the present invention, the user interface of modular communicator 100 includes a touch-sensitive display screen 185, which is positioned at the surface of netbook computer 200 close to keyboard 280, when modular communicator 100 is connected to netbook computer 200.

In accordance with applicant's co-pending patent application U.S. Ser. No. 12/151,079, filed on May 3, 2008, entitled MODULAR CELL PHONE FOR LAPTOP COMPUTERS and co-pending patent application U.S. Ser. No. 12/415,116, filed on Mar. 31, 2009, entitled MODULAR CELL PHONE FOR FIXED MOBILE CONVERGENCE, the contents of which are hereby incorporated by reference, when modular communicator 100 is connected to netbook computer 200, it is operable in conjunction with netbook computer 200 for communication and for data sharing. Moreover, the user interface of modular communicator 100 becomes part of the user interface of netbook computer 200.

As such, touch-sensitive display screen 185 functions as a pointing device for netbook computer 200. In a first embodiment of the present invention, netbook computer 200 has its own pointing device, such as a touch pad, and touch-sensitive display screen is operative in lieu of or in addition to the pointing device of netbook computer 200. In a second embodiment of the present invention, netbook computer 200 does not have its own pointing device, and touch-sensitive display screen 185 provides the pointing device for netbook computer 200, when modular communicator 100 is connected to netbook computer 200. It will be appreciated by those skilled in the art that netbook computer 200 may be manufactured more compact and light-weight when designed for the second embodiment, than when designed for the first embodiment.

In the first embodiment mentioned hereinabove, touch-sensitive display screen 185 may function as (i) a secondary pointing device for netbook computer 200, (ii) a user interface for one or more applications that run on netbook computer 200, and/or (iii) soft keys for netbook computer 200.

In both embodiments of the present invention, touch-sensitive display screen 185 may display system messages and notifications for netbook computer 200, when modular communicator 100 is connected to netbook computer 200. Such system messages and notifications include inter alia a power bar, a network status and a storage capacity.

For netbook computers with covers that open and close, modular communicator 100 may be connected to netbook computer 200 in either of two configurations. According to the first configuration, display screen 185 is visible and accessible when the cover of mobile computer 200 is open, as shown in FIG. 4. According to the second configuration, display screen 185 is visible and accessible when the cover of netbook computer 200 is closed, as shown in FIGS. 5 and 6.

For netbook computers with tablet forms factors, which do not have covers that open and close, configurations with display screen 185 facing the front and the back are shown respectively in FIGS. 7 and 8.

It will be appreciated by those skilled in the art that modular communicator 100 is generally carried by a user for use as cell phone. As such, unlike prior art pointer devices which are cumbersome to carry, there is no additional burden on the user of carrying touch-sensitive display screen 185 with him.

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

What is claimed is:

1. A communication system, comprising:
a modular wireless communicator, comprising:
a modem for transmitting and receiving signals wirelessly; and
a touch-sensitive display; and
a mobile computer, comprising:
a housing with a cavity for inserting said modular wireless communicator therein such that said touch-sensitive display is exposed through the housing and accessible for user inputs; and
a processor, mounted within said housing, for controlling said modem and for running an operating system that performs computer tasks in response to user inputs detected by said touch-sensitive display, when said modular wireless communicator is inserted in said housing.

2. The communication system of claim 1 wherein said processor interprets user inputs detected by said touch-sensitive display to move a cursor.

3. The communication system of claim 1 wherein said processor interprets user inputs detected by said touch-sensitive display to launch an application.

4. The communication system of claim 1 wherein said mobile computer further comprises a mouse, and wherein said processor uses said touch-sensitive display as a secondary input device when said modular wireless communicator is inserted in said housing.

5. The communication system of claim 1 wherein said processor displays notifications about said mobile computer on said touch-sensitive display, when said modular wireless communicator is inserted in said housing.

6. The communication system of claim 5 wherein the notifications include a power bar indicating whether the mobile computer is being powered from an external source or from an internal battery.

7. The communication system of claim 5 wherein the notifications include a network status indicating whether the mobile computer is connected to a computer network.

8. The communication system of claim 5 wherein the notifications include a storage status, indicating available storage capacity of the mobile computer.

9. A modular wireless communicator, comprising:
a modem for transmitting and receiving signals wirelessly;
a touch-sensitive display; and
an electrical connector, coupled with said modem and with said touch-sensitive display, for connection to a mobile computer, wherein said modem serves as a modem for the mobile computer and the touch-sensitive display serves as a touch-based input device for the mobile computer, when said electrical connector is connected to the mobile computer.

10. A mobile computer, comprising:
a housing with a cavity for inserting a modular wireless communicator therein, the modular wireless communicator including a modem and a touch-sensitive display, wherein the touch-sensitive display is exposed through the housing and accessible for user inputs when the modular wireless communicator is inserted in the housing; and
a processor, mounted within said housing, for controlling the modem and for running an operating system that performs computer tasks in response to user inputs detected by the touch-sensitive display, when the modular wireless communicator is inserted in said housing.

11. The mobile computer of claim 10 wherein said processor interprets user inputs detected by the touch-sensitive display to move a cursor.

12. The mobile computer of claim 10 wherein said processor interprets user inputs detected by the touch-sensitive display to launch an application.

13. The mobile computer of claim 10 further comprising a mouse, and wherein said processor uses the touch-sensitive display as a secondary input device when the modular wireless communicator is inserted in said housing.

14. The mobile computer of claim 10 wherein said processor displays notifications on the touch-sensitive display, when the modular wireless communicator is inserted in said housing.

15. The mobile computer of claim 14 wherein the notifications include a power bar indicating whether the mobile computer is being powered from an external source or from an internal battery.

16. The mobile computer of claim 14 wherein the notifications include a network status indicating whether the mobile computer is connected to a computer network.

17. The mobile computer of claim 14 wherein the notifications include a storage status, indicating available storage capacity of the mobile computer.
